(19) United States
(12) Patent Application Publication
(10) Pub. No.: US 2010/0033772 A1
(43) Pub. Date: Feb. 11, 2010

(54) Multi-page Scanner/Copier and technique/method to simultaneously scan without separating pages or uncoupling documents or books

(76) Inventors: Craig Steven Borison, Northridge, CA (US); Susan Ha Kyung Yoon, Northridge, CA (US)

Correspondence Address: Craig Borison, 11723 Coorsgold Lane, Northridge, CA, 91326, US

(21) Appl. No.: 12/538,172

(22) Filed: Aug. 10, 2009

Related U.S. Application Data
(60) Provisional application No. 61/087,594, filed on Aug. 8, 2008.

(51) Int. Cl. H04N 1/04

(52) U.S. Cl. 358/474

(57) ABSTRACT

A system and method to scan and/or copy virtually simultaneously all of the pages of books, multiple-page documents and/or other printed or illustrated material without requiring the opening of the book, one at a time page separation nor dismantling/uncoupling of documents by scanning multiple pages all at once and using software to interpret the printed or colored areas on each plane or page to copy and create digital images of the individual pages of the original item scanned. In one embodiment or implementation, penetrating scanning beams will deliver a three-dimensional image of a book, stack of printed papers, magazine, etc. to a CPU and individual pages will be detected and distinguished and a image of each page shall be created. After processing the images with optical character recognition then the text of the documents can be indexed and searched and accessed by network users. In a second embodiment, after the three-dimensional image of the entire book is sent to a CPU the user can manually determine the individual page delineations and/or in the case of a damaged or faded book the depth of where the image will be retrieved.

### CROSS-REFERENCE TO RELATED APPLICATIONS

Priority is hereby claimed to that certain Provisional patent application entitled “Multi-page Scanner/Copier and technique to simultaneously scan without separating pages or decoupling documents or books” with U.S. Application No. 61/087,594 filed on Aug. 8, 2008 by Applicants Craig Steven Borison and Susan Ha Kyung Yoon and confirmed by Filing Receipt mailed Aug. 22, 2008 and having the Confirmation No. 6250.

### STATEMENT REGARDING FEDERALLY SPONSORED RESEARCH OR DEVELOPMENT

Not applicable.

### REFERENCE TO SEQUENCE LISTING A TABLE, OR A COMPUTER PROGRAM LISTING COMPACT DISC APPENDIX:

Not applicable.

### BACKGROUND OF INVENTION

A. Field of Invention

The systems, devices, methods and techniques described herein relate to an image scanning and copying multiple pages in documents such as books, magazines, catalogs, government records, legal documents, general records, printed and illustrated documents and the like and also to scanning, searching, indexing, archiving and locating features in these kinds of documents.

B. Description of Related Art

The Internet and also proprietary networks have made large amounts of information widely accessible to users of these computer networks. Search engines and organizations that offer content for download have made it possible for computer user connected to such a computer network to search and locate relevant information simply by entering a query into a search engine and thereby finding information, including but not limited to, web pages, web documents, books, magazines, catalogs, government records, legal documents, general records, printed and illustrated documents some of which can be downloaded to electronic book reader devices.

While most magazines, catalogs, government records, legal documents, general records, printed and illustrated documents are now created in digital or electronic form or immediately converted to a digital format, all of these categories of documents created before the advent of easily-created digital or electronic forms remain in large part unavailable to users of computer networks.

One barrier to making these categories of easily and widely available is the time intensive, expensive and laborious task of converting these categories of documents to digital or electronic form. Additionally, some older works can be irreparable harmed by the physical nature of the scanning process. Scanning technologies for the most part have involved and required physically placing of open books face down on a scanning surface or scanning/photographing the open book from above. Either way, the books need to be opened. Some books are deteriorating in collections across the globe and cannot be scanned without destroying the work. Other documents could be unbound or decoupled to make use of an automatic document reader. Page turning and placing each individual page or two pages in an open book requires, usually, some or a great deal of human input as does the decoupling process.

Once scanned, the information relating to a particular page is merely an image of that page and cannot be easily searched or indexed. The scanned images, however, can be then converted utilizing optical character recognition (“OCR”) which processes the images into text in a computer format. Once converted to text, the information can be easily indexed and searched.

Book documents may be warped by age or by the way in which they are stored. When individual pages are inconsistently curved, then the scanned image may be distorted. Since OCR requires a good image with little warping or curvature from the book, in other words it requires a two dimensional image of the page true to the original dimensions and without warping it would be beneficial to correct the warping before it is processed with OCR technology.

Since this system and/or method would detect the individual pages and the void space in between each page then the curvature could be measured against the original dimensions of the pages and de-warped to a flat two-dimensional image for the OCR technology to process and more easily convert to text.

### BRIEF SUMMARY OF THE INVENTION

To solve the above-outlined problems, the present invention provides a method and system capable of scanning simultaneously an entire stack of documents or book-like documents and also detecting and correcting for any curvature and warping if required.

The device is designed to scan and/or copy virtually simultaneously all of the pages of books, multiple-page documents and/or other printed or illustrated material without requiring the opening of the book, one at a time page separation nor dismantling/uncoupling of documents by scanning multiple pages all at once and using software to interpret the printed or colored areas on each plane or page to copy and create digital images of the individual pages of the original item scanned (the “Device”).

In the following description of the preferred embodiment, reference is made to a specific embodiment in which the Device may be produced. It is understood that other embodiments may be utilized and structured and other changes may be made without departing from the scope of the present Device.

The Device will have a chamber where a book, a pile of books, or stacks of documents (the “Stack”) can be placed. A penetrating imaging or scanning beam utilizing one or more of the following scanning/imaging techniques and/or apparatus, including but not limited to, a spectral scanner, synchrotron radiation induced X-ray fluorescence spectroscopy, X-ray radiography, FT-IR, micro FT-IR, Micro-infrared analysis, X-ray diffraction, liquid chromatography and infrared spectroscopy, infrared micro spectrometry, infrared micro mapping spectrometry, multi-spectral imaging, infrared spectrometer, near-infrared mapping spectrometer, near-infrared spectrometer, MRI or MRI-like scanner, CAT or CAT-like scanner, opacity detecting scanner, PET or PET-like scanner, microfocus X-ray computed tomography or other imaging technology to determine color, black and white, and/or grayscale information (the “Scan”) would either be raised and lowered around the Stack or beamed through from above, below, and/or beside the Stack to collect imaging data. The Scan would discern and record the printed, illustrated or opaque portions of the individual pages of the Stack and would also detect and differentiate printed and unprinted or opaque and non-opaque areas of the Stack on each side of the individual pages of the Stack.

The data collected from the Scan would then be transferred to a CPU or digital storage device as a three-dimensional image of the entire Stack or series of cross-sections or a series of two or three dimensional differentiated planes. This data would then be analyzed and interpreted by software to delineate the printed data and separate out the individual planes of data or pages. The software would also interpret the void space between the pages to delineate between printed pages. This would result in a scan or copy of the original similar if not identical to a traditionally scan or copy of a Stack where individual pages are scanned one at a time.

These individual images of the data or pages could then be utilized either as images or translated by optical character recognition software.

### Use of Device:

Any large or small copying/scanning jobs or archiving and preservation of books and records can be done with the minimum of labor and without damaging the original items. This Device could also be used to scan rare and fragile books and documents in addition to business records and other printed material.

These and other objects, advantages and features of the invention are illustrated by the following description thereof taken in conjunction with the accompanying drawings which illustrate the specific embodiments of the invention.

### BRIEF DESCRIPTION OF THE SEVERAL VIEWS OF THE DRAWING

The accompanying drawings, which are incorporated in and constitute a part of this specification, illustrate an embodiment of the invention and, together with the description, explain the invention. In the drawings,

FIG. 1 is a diagram illustrating a book that is to be scanned;

FIG. 2 is a diagram illustrating the void spaces on either side of one individual page in a book-like document, the printed face of the top side of a page face (the obverse face of the page), the middle portion/plane of the paper making up the page located between the two printed faces of the paper, and the face of the bottom side of the same page (the reverse face of the page);

FIG. 3 is a diagram illustrating an exemplary system showing a scanning device utilizing penetrating beam(s) for the scanning of documents, such as books or magazines, to obtain three dimensional images of all of the pages of said documents at once.

FIG. 4 is a flowchart illustrating an exemplary implementation and operations of a system to process an entire book-like document.

### DETAILED DESCRIPTION OF THE INVENTION

The following detailed description of the invention refers to the accompanying drawings. This detailed description shall not construed in any way to limit the invention.

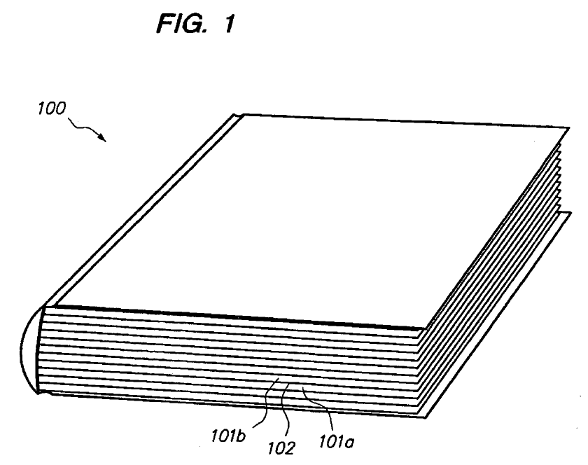

FIG. 1 is a diagram illustrating a book 100 that is to be scanned. Void space 101a of book 100 represents the void space immediately preceding and void space 101b of book 100 represents the void space immediately succeeding page 102 which represents an individual page of book 100. Anything facing void space 101a or 101b is potentially a printed image on the surface of the page 102.

It may be desirable to perform image processing functions, such as OCR functions, on the scanned images of book 100. Before performing such functions, it will be necessary to locate void space 101a and void space 101b of the book 100.

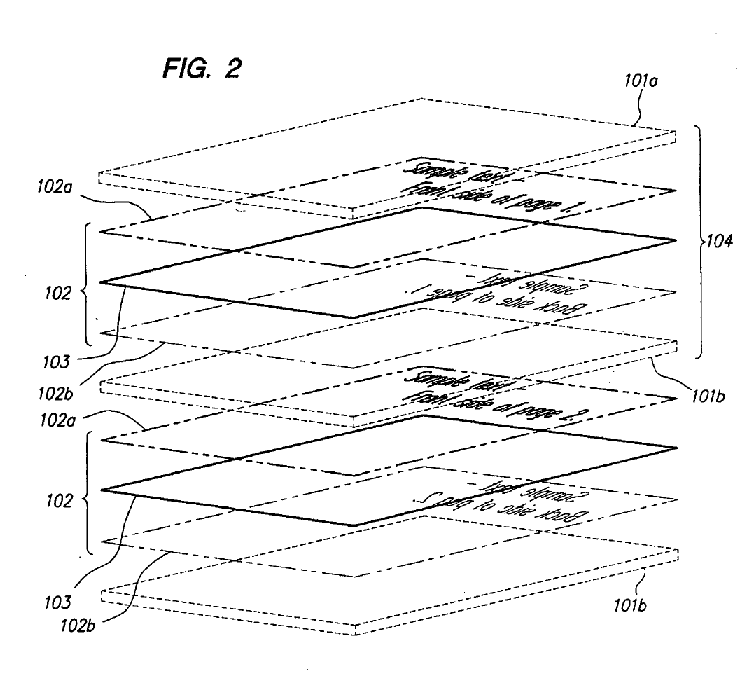

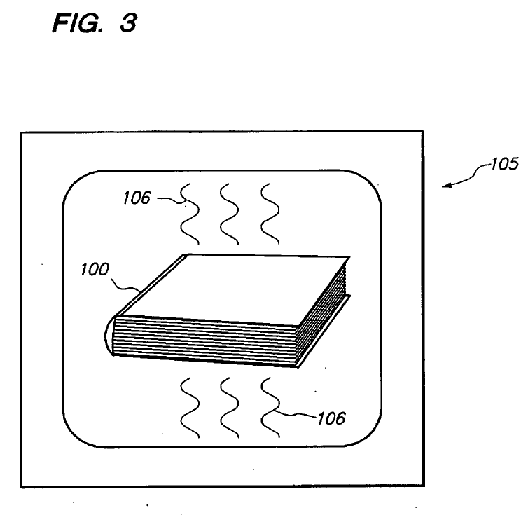

FIG. 2 is a diagram illustrating a top view of page 102 of book 100. From this view, it can be seen that page 102 preceded on top with void space 101a and succeeded beneath by void space 101b, page 102 is further broken down as a cross-section containing printed images on the top face of page 102 identified as 102a (obverse side of page 102) and printed images on the opposite bottom face of page 102 identified as 102b (reverse side of page 102). Sandwiched between the printed obverse 102a and the reverse 102b is the actual middle plane of paper 103. Finally, the page 102 is preceded by void space 101a on one side and void space 101b on the other side. The entire cross-section 104 repeats itself for the rest of book 100.

FIG. 3 is a diagram illustrating device 105 which is an exemplary system of a three dimensional scanning device incorporating penetrating beam(s) 106. Book 100 is not opened or disturbed during the scanning process.

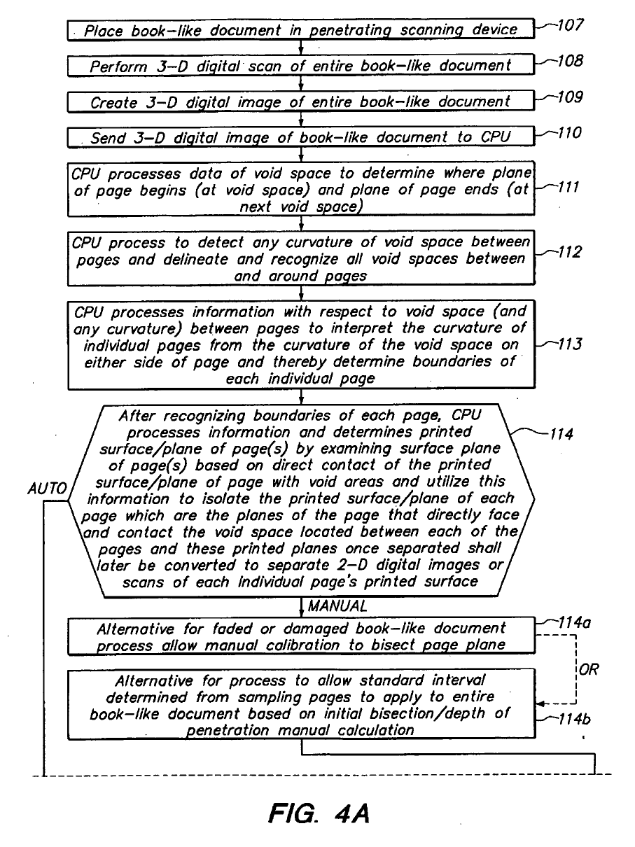

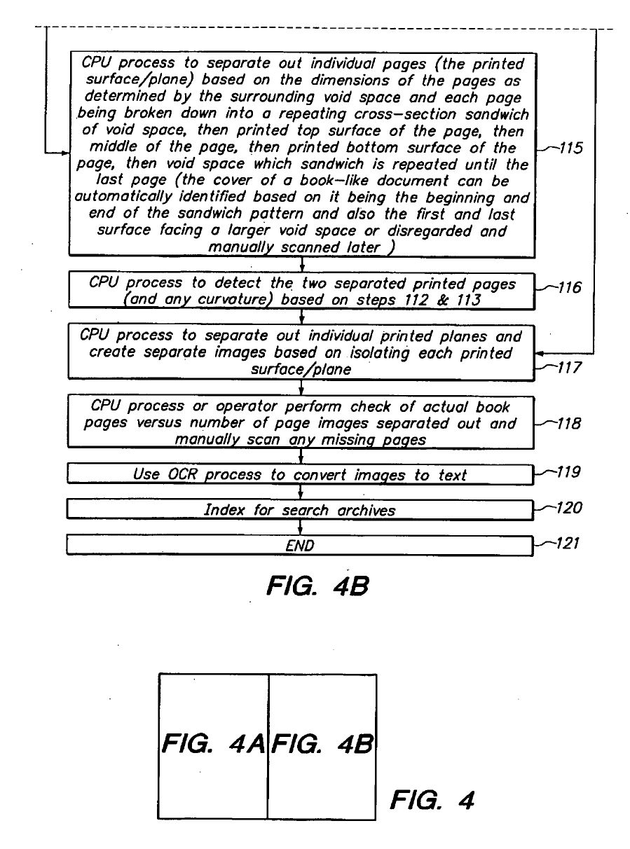

FIG. 4 is a diagram illustrating as exemplary implementation of the method for the invention. First, a book is placed in a three dimensional scanning device incorporating penetrating beam(s) (107); then, a three-dimensional scan of the entire book-like document is performed (108); a digital three dimensional image of the entire book-like document is created (109); said digital three dimensional image is transferred to a CPU or other processor device (110); a CPU or other processor device processes the digital three dimensional image to determine the void space in between the pages to determine where the top of the plane of each page begins (at preceding void space) and where the bottom of the plane of each page ends (at the succeeding void space) The three-dimensional set of points may be processed to locate the page surfaces (111); CPU or other processor device individually detects the curvature of each of the void spaces, if any, between the pages (112) CPU or other processor device process the information relating to the curvature, if any, of the various void spaces and calculate the curvature of the individual pages sandwiched between the void spaces and uses that information to de-warp the images if necessary (113); CPU or other processor device processes the information and determines the printed planes by examining the printed faces of the page in direct contact with the void areas between the said page (top side of page and bottom side of page). The three-dimensional set of points may be processed to locate the printed surfaces and to produce individual digital images of the individual pages (114), or alternatively, in the case of a faded or damaged book-like document the process would allow manual calibration of where to bisect the page's plane (the depth of penetration into the paper of each page for each separate digital image of each page so that in the case of a faded page where the printed area or ink may be clearer at a subsurface level or plane) (114a) or the process would allow a standard interval to be determined with some sampling of pages and this depth penetration would be applied to the entire book-like document to produce the separate images of the pages based on the initial bisection/depth of penetration manual calculation (114b); CPU or other processor device process information to separate out individual pages with printed face(s) as distinct images of each page (115) CPU or other processor device to detect two separate planes on each side of each page and to detect and correct for any curvature as set forth in 112 & 113 above (116); CPU or other processor device separates out and creates individual separate images of the printed pages comparable or superior to the output from a flatbed scanner (117); CPU or other processor device perform check of actual printed pages versus the number of pages as entered by a human operator or OCR operation to find any discrepancies (which missed pages can be scanned manually) (118); CPU or other processor device to process with OCR software to convert images to text (119); CPU or other processor device can then index for search or archive or make available for download for computers, e-readers such as Kindle II, iPods, iTouch or other devices (120) and end of this embodiment (121).

### OVERVIEW

The system and method is designed to scan and/or copy virtually simultaneously all of the pages of books, multiple-page documents and/or other printed or illustrated material without requiring the opening of the book, one at a time page separation nor dismantling/uncoupling of documents by scanning multiple pages all at once and using software to interpret the printed or colored areas on each plane or page to copy and create digital images of the individual pages of the original item scanned (the “Device”).

In the following description of the preferred embodiment, reference is made to a specific embodiment in which the Device may be produced. It is understood that other embodiments may be utilized and structured and other changes may be made without departing from the scope of the present Device.

The Device will have a chamber where a book, a pile of books, or stacks of documents (the “Stack”) can be placed. A penetrating imaging or scanning beam utilizing one or more of the following scanning/imaging techniques and/or apparatus, including but not limited to, a spectral scanner, synchrotron radiation induced X-ray fluorescence spectroscopy, X-ray radiography, FT-IR, micro FT-IR, Micro-infrared analysis, X-ray diffraction, liquid chromatography and infrared spectroscopy, infrared micro spectrometry, infrared micro mapping spectrometry, multi-spectral imaging, infrared spectrometer, near-infrared mapping spectrometer, near-infrared spectrometer, MRI or MRI-like scanner, CAT or CAT-like scanner, opacity detecting scanner, PET or PET-like scanner, microfocus X-ray computed tomography or other imaging technology to determine color, black and white, and/or grayscale information (the “Scan”) would either be raised and lowered around the Stack or beamed through from above, below, and/or beside the Stack to collect imaging data. The Scan would discern and record the printed, illustrated or opaque portions of the individual pages of the Stack and would also detect and differentiate printed and unprinted or opaque and non-opaque areas of the Stack on each side of the individual pages of the Stack.

The data collected from the Scan would then be transferred to a CPU or digital storage device as a three-dimensional image of the entire Stack or series of cross-sections or a series of two or three dimensional differentiated planes. This data would then be analyzed and interpreted by software to delineate the printed data and separate out the individual planes of data or pages. The software would also interpret the void space between the pages to delineate between printed pages. This would result in a scan or copy of the original similar if not identical to a traditionally scan or copy of a Stack where individual pages are scanned one at a time.

These individual images of the data or pages could then be utilized either as images or translated by optical character recognition software.

### Use of Device:

Any large or small copying/scanning jobs or archiving and preservation of books and records can be done with the minimum of labor and without damaging the original items. This Device could also be used to scan rare and fragile books and documents in addition to business records and other printed material.

Penetrating beam imaging devices and scanning have been commercialized. Using these devices a three-dimensional digital image can be created and analyzed layer by layer.

The Device, systems and method can utilize other penetrating beam/scanning devices, the Scan, such as X-ray transmission microscopy utilizing elemental specificity of x-ray absorption, ultra-violet photoelectron spectroscopy, photoemission spectroscopy, soft x-rays emitted from laser-produced plasma rather than synchrotron radiation, Zero Electron Kinetic Energy spectroscopy, Auger electron spectroscopy, energy dispersive X-ray spectroscopy, which detects ejected x-rays following stimulation by charged particles, X-ray photoelectron spectroscopy, neutron radiography (NR, Nray, or neutron imaging). Additionally, X-rays cause fluorescence in most materials, and these emissions can be analyzed to determine the chemical elements of an imaged page, in other words, the printed elements of a page can be distinguished from the paper of the page itself. Another technology that can be used is neutron radiography. Since neutron radiography can see very different things than X-rays, for example neutrons pass through metals but are interfered with by other materials/molecules such as water and oils then a number of different penetrating beam/scanning devices utilizing different wavelengths and/or techniques can be used in conjunction with each other to take advantage of each the penetrating beams' particular strengths and characteristics to produce a three-dimensional image of the Stack that can be analyzed and used to differentiate between the various printed pages and printing on those pages.

For example, neutron radiation can be used to detect the amount of radiation emerging from the opposite side of an individual page which can be detected and measured, variations in this amount (or intensity) of radiation can be used to determine thickness or composition of material. The measurements can be made page after page thereby measuring the neutron radiation beam emerging from the last page thereby determining the planes occupied by each page in a book.

Additionally, elemental and molecule differentiation can be utilized from one or more of the beam technologies described above. Also exciting or heating the molecules of certain portions of the pigmented or non-pigmented areas can allow for the differentiation of the separate pages.

The penetrating beams can also be passed through the book from all angles to help compensate for the issue that some beams cannot penetrate certain elements and/or molecules.

Another embodiment, utilizes the three-dimensional image as sent to the CPU before the processor determines the void space and the printed parts of the pages.

### Potential for Exploitation in Industry

According to the present invention, by simultaneously scanning by penetrating beam all of the pages of a book-like document, the process of scanning, archiving and creating OCR text of those scanned images, book-like documents and making that information available would be greatly accelerated and cost less time and money and older fragile, compromised and/or vulnerable book-like documents could scanned virtually without damage and preserved for future generations.

### CONCLUSION

Techniques for scanning entire book-like documents, such as a book, legal records or a magazine was described herein. In one implementation, the individual pages are separated out and saved as individual images of the pages even though the entire book-like documents was scanned all at once.

The foregoing description of the preferred embodiments of the invention have been presented for purposes of illustration and description. It is not intended to be exhaustive or to limit the invention to the precise form disclosed, and modifications and variations are possible in light of the above teachings or may acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the invention is not limiting of the invention. Thus, the operation and behavior of the aspects were described without reference to the specific software code—it being understood that a person of ordinary skill in the art would be able to design software and control hardware to implement the aspects based on the description herein.

The foregoing description of preferred embodiments of the invention provides illustration and description, but is not intended to be exhaustive or to limit the invention to the precise form disclosed. Modifications and variations are possible in light of the above teachings or may be acquired from practice of the invention. For example, although many of the operations described above were described in a particular order, many of the operations are amenable to being performed simultaneously or in different orders to still achieve the same or equivalent results.

Although the present invention has been fully described by way of examples with reference to the accompanying drawings, it is to be noted that various changes and modifications will be apparent to those skilled in the art. Therefore, unless otherwise such changes and modifications depart from the scope of present invention, they should be construed as being included therein.

No element, act, or instruction used in the present application should be construed as critical or essential to the invention unless explicitly described as such. Also, as used herein, the article “a” is intended to potentially allow for one or more items. Further, the phrase “based on” is intended to mean “based, at least in part, on” unless explicitly stated otherwise.

What is claimed:

1. A system comprising: a penetrating beam device that can scan and output to a CPU a three-dimensional contrasting image showing density of the layers of an entire closed book-like document; software to process the three-dimensional image to distinguish between light and dark areas and/or printed and unprinted page surfaces and/or the fluorescence or non-cause fluorescence of different elements, software to process and define the void space between the individual pages; software to detect and correct for any curvature or other page surface distortions based on the detection of void space between individual pages, software to process and separate out the individual pages images to allow for the images to be converted to text via OCR, archived and indexed and searched.

2. The system of claim 1, wherein the book-like document is a book.

3. The system of claim 1, wherein the book-like document is a magazine or catalog.

4. The system of claim 1, wherein the book-like document is a stack of individual documents.

5. The system of claim 1, wherein the book-like document is an old potentially faded printed item where the pigmented areas are subsurface of the individual page faces but where the plane of.

6. The system of claim 1, wherein one can manually detect the subsurface pigmentation areas to use as image planes in the case of a faded or damaged book-like document the process would allow manual calibration of where to bisect the page's plane (the depth of penetration into the paper of each page for each separate digital image of each page so that in the case of a faded page where the printed area or ink may be clearer at a subsurface level or plane) or the process would allow a standard interval to be determined with some sampling of pages and this depth penetration would be applied to the entire book-like document to produce the separate images of the pages based on the initial bisection/depth of penetration manual calculation
A computer-implemented method for detecting a void space and the printed portion of pages in a book-like document, the method comprising: generating separate images of individual pages.

7. An image scanner comprising:
A penetrating beam(s) device that emits a penetrating beam(s) that creates and creates a three-dimensional digital image of the entire book-like document;
Opacity/contrast detector for dividing between darker and lighter portions of three-dimensional images differing opacity/contrast;
Detecting method to detect the void space or less dense areas of a three-dimensional digital image of the entire book-like document to detect between individual pages of the said book's image;
